(19) United States
(12) Patent Application Publication
(10) Pub. No.: US 2008/0266712 A1
(43) Pub. Date: Oct. 30, 2008

(54) External hard disk box

(76) Inventor: Chien-Da Hu, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,921

(22) Filed: Apr. 30, 2007

(51) Int. Cl. G11B 23/03

(52) U.S. Cl. 360/133

(57) ABSTRACT

An external hard disk box is used for installing a hard disk. On the bottom and on two sides of the hard disk, there is a first fastening hole and a second fastening hole. The external hard disk box includes a lower cover, an upper cover, and two positioning structures. The lower cover has a receiving space. On the bottom surface of the receiving space, there is a first positioning portion that corresponds to the first fastening hole. The upper cover covers the lower cover. The two positioning structures are respectively located on two sides of the receiving space. Each positioning structure has a second positioning portion that corresponds to the second fastening hole of the hard disk. By using the first positioning portion and the second positioning portion, the hard disk is firmly positioned in the hard disk box. Screws are not needed.

### BACKGROUND OF THE INVENTION

1. Field of the Invention

The present invention relates to an external hard disk box. In particular, this invention relates to an external hard disk box that can position the hard disk without using screws.

2. Description of the Related Art

The external hard disk box of the prior art includes a lower cover. Two sides of the lower cover have a plurality of holes. The hard disk is received in the lower cover. On two sides of the hard disk, there is a plurality of hastening holes that correspond to the holes of the lower cover. An upper cover covers the lower cover. Screws pass through the holes of the lower cover and are screwed into the fastening holes of the hard disk so that the hard disk is fastened onto the lower cover.

However, when the external hard disk box of the prior art is assembled, it is necessary to use screws to lock and fasten the hard disk. The assembling process is complex, time-consuming. The cost is high.

### SUMMARY OF THE INVENTION

One particular aspect of the present invention is to provide an external hard disk box. It uses the first positioning portion located at the bottom of the hard disk and the second positioning portions located on two sides of the hard disk to position the hard disk in the external hard disk box. The hard disk and the external hard disk box are connected together without screws. The hard disk is firmly positioned in the external hard disk box.

The external hard disk box is used for installing a hard disk therein. On the bottom and on two sides of the hard disk, there is a first fastening hole and a second fastening hole. The external hard disk box includes a lower cover having a receiving space, an upper cover covering the lower cover, and at least two positioning structures respectively located on two sides of the receiving space. On the bottom surface of the receiving space, there is a first positioning portion that corresponds to the first fastening hole. Each positioning structure has a second positioning portion that that corresponds to the second fastening hole.

The present invention has the following characteristics. The external hard disk box of the present invention has a screw-free design. When the hard disk is assembled, the hard disk is firmly positioned in the hard disk box without screws. The time needed for installing and uninstalling the hard disk is reduced. It is easy and convenient, and the cost of the screws is eliminated.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the first embodiment of the present invention;

FIG. 2 is another exploded perspective view of the first embodiment of the present invention;

FIG. 3 is a cross-sectional view of the first embodiment of the present invention;

FIG. 4 is an exploded perspective view of the second embodiment of the present invention;

FIG. 5 is an exploded perspective view of part of the second embodiment of the present invention;

FIG. 6 is another exploded perspective view of part of the second embodiment of the present invention;

FIG. 7 is an exploded perspective view of the third embodiment of the present invention;

FIG. 8 is a schematic diagram of the frame of the upper cover of the third embodiment of the present invention being not positioned; and

FIG. 9 is a schematic diagram of the frame of the upper cover of the third embodiment of the present invention being positioned.

### DETAILED DESCRIPTION OF THE PREFERRED EMBODIMENTS

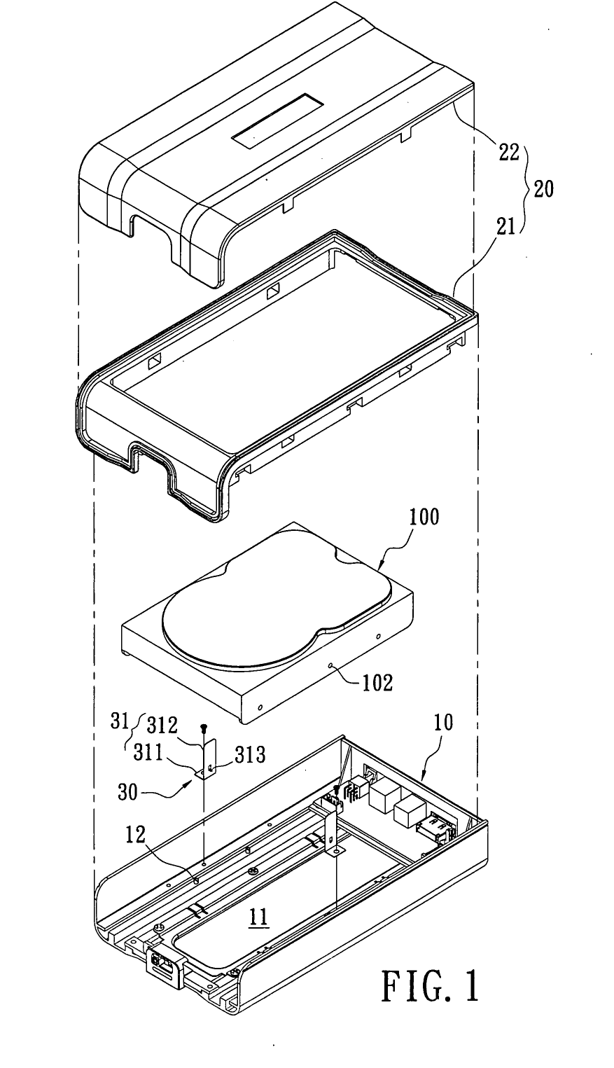

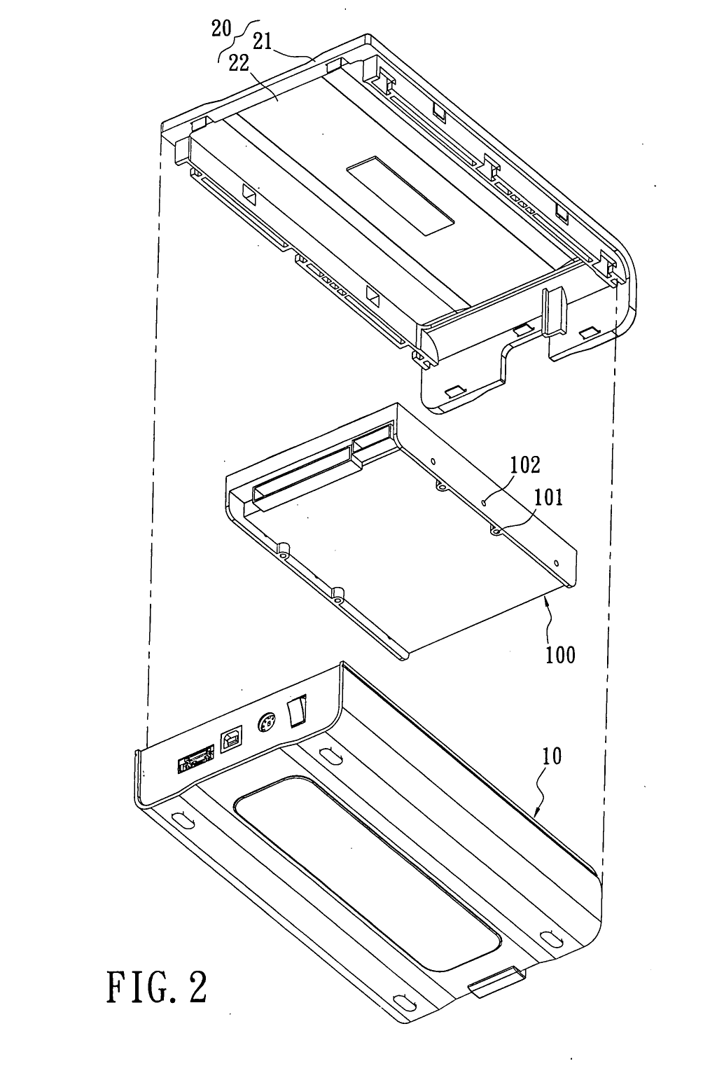

Reference is made to FIGS. 1 and 2, which shows the first embodiment of the present invention. The external hard disk box includes a lower cover 10, an upper cover 20, and two positioning structures 30.

In the interior of the lower cover 10, there is a receiving space 11 for receiving a hard disk 100. There are four first fastening holes 101 (refer to FIG. 2) and three second fastening holes 102 on the bottom surface and two side surfaces of the hard disk 100.

There are four first positioning portions 12 protruding from the bottom surface of the receiving space 11 of the lower cover 10. The first positioning portions 12 correspond to the first fastening holes 101 of the hard disk 100.

In this embodiment, each positioning structure is a flexible flake 31. The flexible flake 31 has a bottom board 311 and a side board 312. The bottom board 311 that is adjacent to the receiving space 11 extends upwards to form the side board 312. The middle portion of the side board 312 is punched to form a second positioning portion 313. The second positioning portion 313 extends into the receiving space 11 and corresponds to the second fastening hole 102 of the hard disk 100.

The upper cover 20 includes a frame 21, and a covering board 22 covering the top surface of the frame 21. On the surface of the covering board 22, there is a plurality of screen holes (not shown in the figure) to exhaust heat of the hard disk 100.

The bottom boards 311 of the two flexible flakes 31 are located in the interior of the lower cover 10 and are close to two sides of the lower cover 10. Therefore, the two positioning structures 30 are respectively installed on two sides of the receiving space 11. The upper cover 20 covers the lower cover 10, and forms an enclosed box with the lower cover 10.

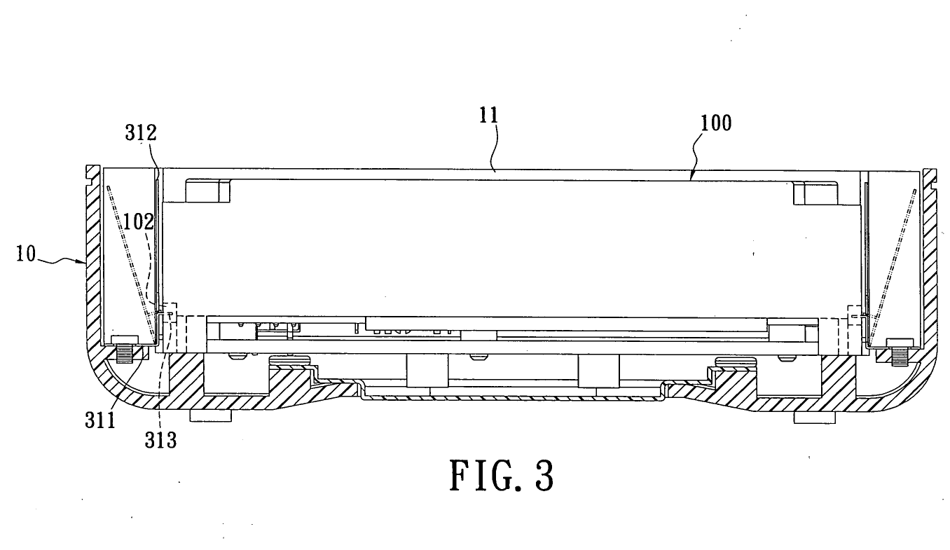

Reference is made to FIG. 3. When the hard disk 100 is assembled, the side boards 312 of the two flexible flakes 31 are pulled forward to an outside of the lower cover 10 (shown in the FIG. 3 as a dash line) to deform the side boards 312 and receive the hard disk 100 in the receiving space 11. Next, the first positioning portion 12 is plugged into the first fastening hole 102 located on the bottom surface of the hard disk 100 to prevent the hard disk 100 from moving forwards and backwards. The side boards 312 are released and recovered to its original position to plug the second positioning portion 313 into the second fastening hole 102 located on the side surface of the hard disk 100 to prevent the hard disk 100 from moving upwards or downwards. Thereby, the hard disk 100 is firmly positioned in the interior of the lower cover 10. Finally, the upper cover 20 covers the lower cover 10.

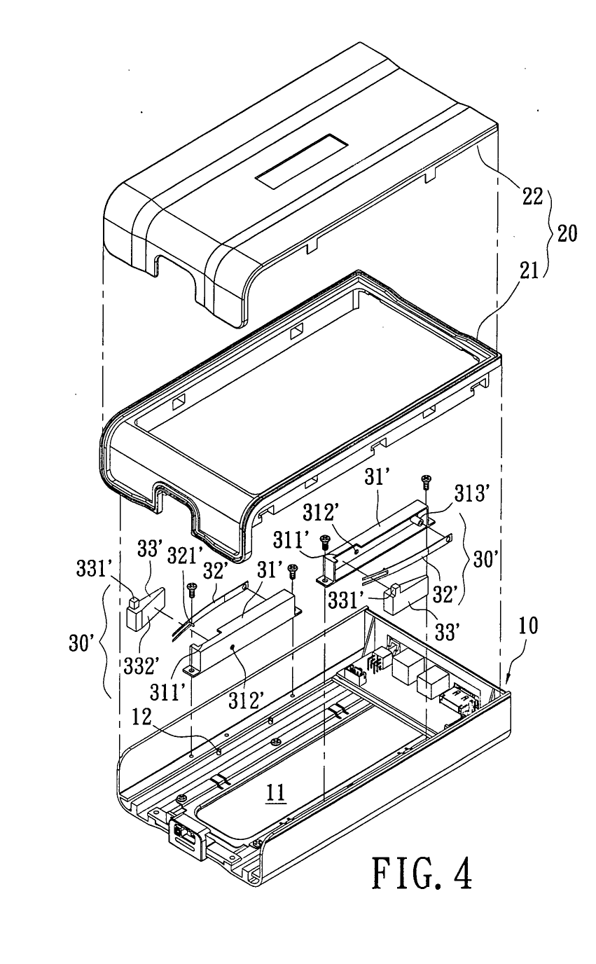

Reference is made to FIGS. 4˜6, which show the second embodiment of the present invention. The difference between the second embodiment and the first embodiment is:

The positioning structure 30′ includes an external mask 31′, a spring flake 32′, and a pushing element 33′. On the top of the external mask 31′, there is an opening slot 311′. A circular through hole 312′ is on a side surface of the external mask 31′. A fastening column 313′ protrudes from an inner wall of the external mask 31′.

The spring flake 32′ is an arced flake. The rear end of the spring flake 32′ is connected with the fastening column 313′ of the external mask 31′. The front end of the spring flake 32′ is a free end, and is bent to form a second positioning portion 321′. The second positioning portion 321′ corresponds to the through hole 312′ of the external mask 31′ for fitting into the second fastening hole 102 of the hard disk 100 (as shown in FIG. 2).

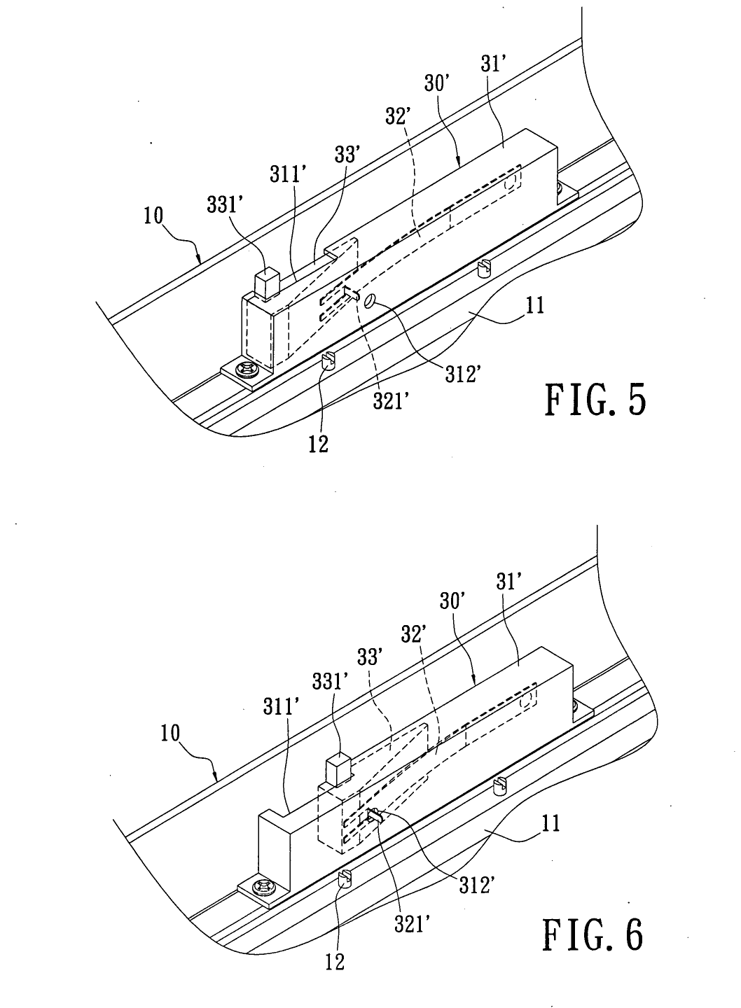

A push button 331′ protrudes from the top surface of the pushing element 33′. One side of the pushing element 33′ forms an inclined plane 332′. The inclined surface 332′ pushes and contacts one side of the front end of the spring flake 32′. The pushing element 33′ is slidably installed in the interior of the external mask 31′, and can be switched between a releasing location (as shown in FIG. 5) and a fastening location (as shown in FIG. 6). The pushing button extends into the opening slot 311′ of the external mask 31′ so that the user can push the pushing element 33′.

Reference is made to FIG. 5. When the pushing element 33′ is located at the releasing location, the second positioning portion 321′ of the spring flake 32′ is located in the interior of the external mask 31′. At this moment, the hard disk 100 is placed into the receiving space 11.

Reference is made to FIG. 6. When the pushing element 33′ is pushed to the fastening location, the inclined surface 332′ located on one side of the pushing element 33′ pushes and contacts the front end of the spring flake 32′ to move forward to the receiving space 11. Therefore, the second positioning portion 321′ passes through the through hole 312′ of the external mask 32′, and protrudes to an outside of the external mask 31′ and extends into the receiving space 11. Thereby, when the hard disk 100 is placed into the receiving space 11, the second positioning portion 312′ is plugged into the second fastening hole 102 of the hard disk to prevent the hard disk 100 from moving upwards or downwards.

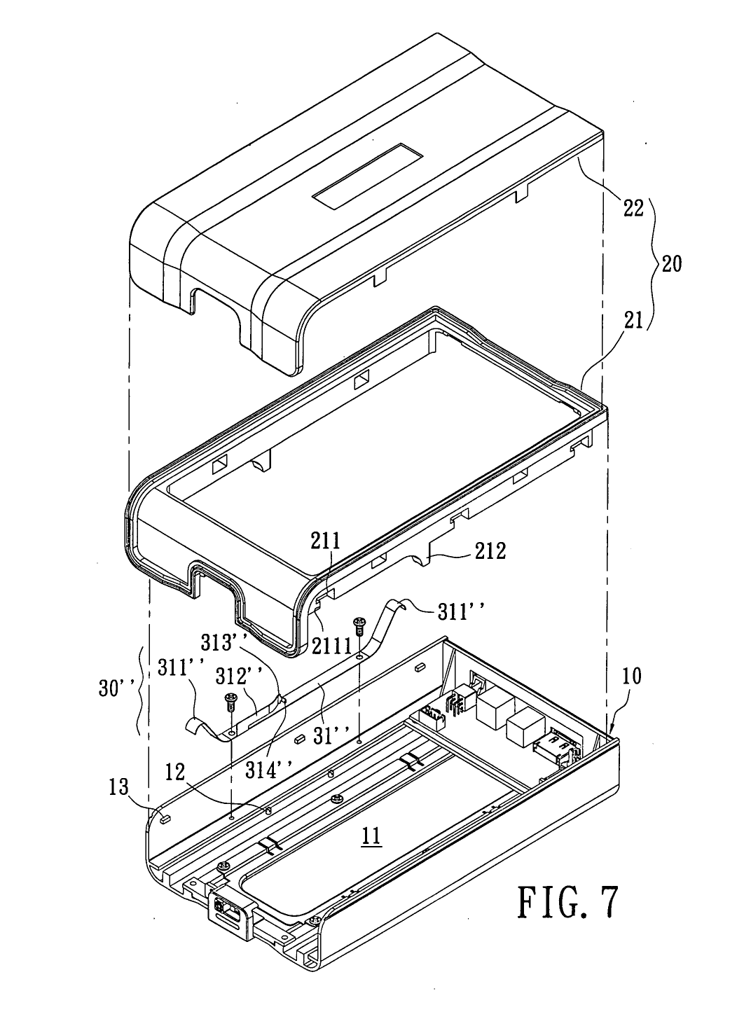

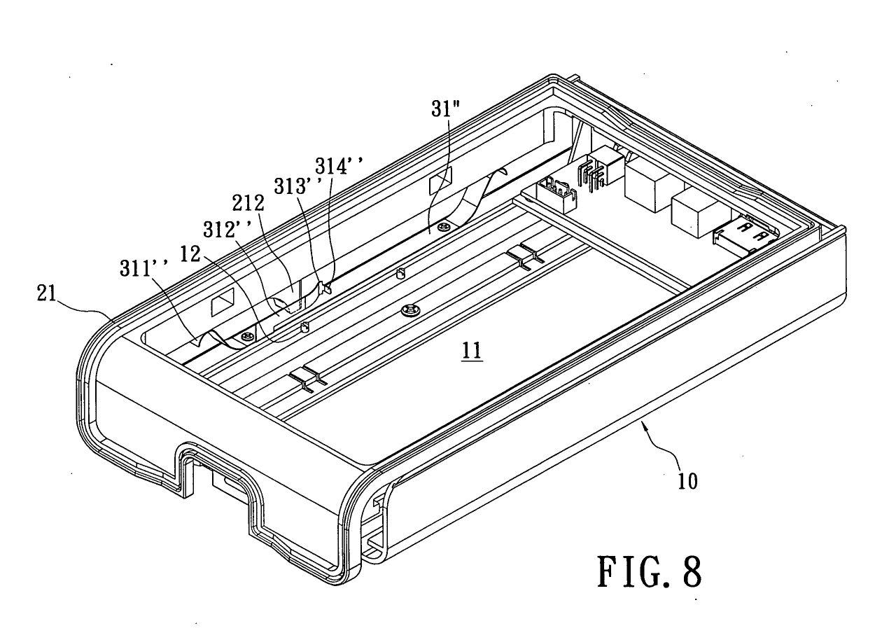

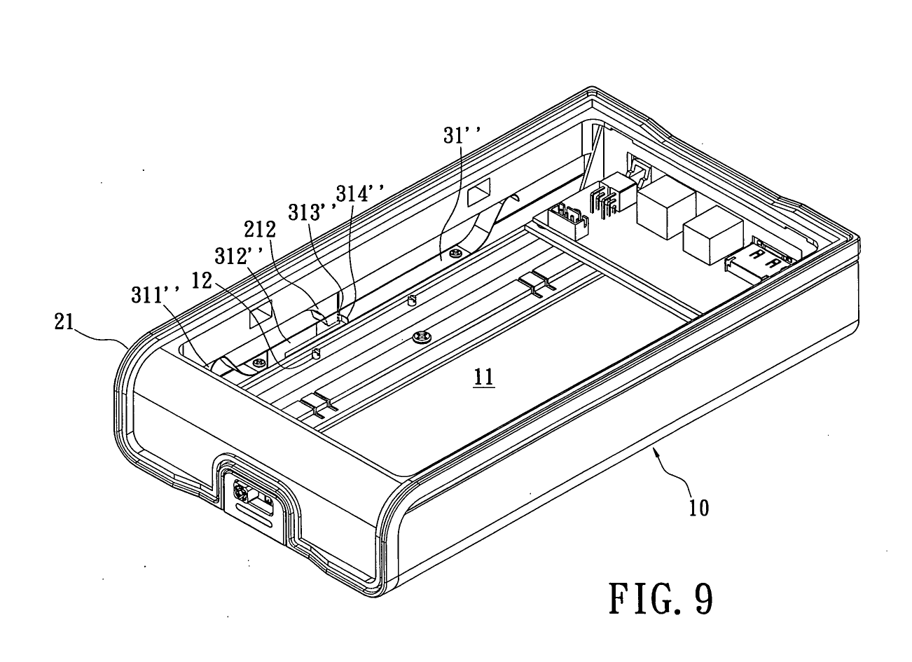

Reference is made to FIGS. 7˜9 (the covering board 22 is not shown in FIGS. 8 and 9), which shows the third embodiment of the present invention. The difference between the third embodiment and the first embodiment is:

Two leg columns 212 respectively extend downwards from two sides of the bottom of the frame 21 of the upper cover 20. There is a plurality of first wedged portions and a plurality of second wedged portions on the lower cover 10 and the upper cover 20 so that the upper cover 20 can be slidably assembled with the lower cover 10 in a horizontal direction.

In this embodiment, the first wedged portion is a rib 13. The ribs 13 protrude from an inner surface of two side walls of the lower cover 10, and are disposed at intervals. The second wedged portion is a sliding slot 211. Two side surfaces of the frame 21 of the upper cover 20 indent inwards to form the sliding slots 211. Each sliding slot 211 passes through the bottom surface of the frame 21. A protruding block 2111 protrudes from the inner surface of the sliding surface 211 to wedge with the rib 13.

In this embodiment, the positioning structure 30″ is a flexible element 31″ made of a metal flake. The front end and the rear end of the flexible element 31″ bend upwards to form a curved portion 311″. The flexible element 31″ that is close to the front end bends to form a linking flake 312″. The end of the linking flake 312″ is a free end and forms a pushing portion 313″. The pushing portion 313″ corresponds to the leg column 212 of the upper cover 20, and extends to the receiving space 11 and forms a second positioning portion 314″ for matching the second fastening hole 102 of the hard disk 100.

When the hard disk 100 is assembled, the opening located at a bottom of the sliding slot 211 of the frame 21 aligns with the rib 13 of the lower cover 10 so that the upper cover 20 covers the lower cover (as shown in FIG. 8). At this time, the rib 13 is received in the sliding slot 211. The curved portion 311″ of the flexible element 31″ pushes and contacts the bottom surface of the frame 21 of the upper cover 20. The leg column 212 is located before the pushing portion 313″, and does not contact the pushing portion 313″.

Next, the frame 21 is pushed backwards to slide to the positioning location (as shown in FIG. 9). The leg column pushes the pushing portion 313″ so that the second positioning portion 314″ extends into the receiving space 11. When the hard disk 100 is placed into the hard disk box, the second positioning portion 314″ is plugged into the second fastening hole 102 of the hard disk 100. Thereby, the hard disk 100 is firmly positioned.

When the user wishes to uninstall the hard disk 100, it can be implemented by using the inverse process. When the upper cover 20 slides to the location shown in FIG. 8, the curved portion 311″ of the flexible element 31″ provides a recovery force that faces upwards to push the upper cover 20 to move upwards. Therefore, the user can easily remove the upper cover 20 to take off the hard disk 100.

The external hard disk box of the present invention uses the first positioning portion and the second positioning portion located on the bottom and two sides of the hard disk to prevent the hard disk from moving forwards, backwards, upwards, or downwards, and firmly positions the hard disk in the hard disk box. The hard disk box and the hard disk can be connected together without screws. The assembling process is simplified to reduce the assembling time. The cost of the screws is eliminated to reduce the assembling cost.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An external hard disk box, used for installing a hard disk, wherein there is a first fastening hole and a second fastening hole on a bottom and two sides of the hard disk, the external hard disk box comprising:
a lower cover having a receiving space for receiving the hard disk, wherein there is a first positioning portion that corresponds to the first fastening hole on the bottom surface of the receiving space;
an upper cover covering the lower cover; and
at least one positioning structure located on one side of the receiving space, wherein the positioning structure has a second positioning portion that corresponds to the second fastening hole.

2. The external hard disk box as claimed in claim 1, wherein the positioning structure is located on one side of the hard disk, the first positioning portion is plugged into the first fastening hole, and the second positioning portion is plugged into the second fastening hole.

3. The external hard disk box as claimed in claim 1, wherein the positioning structure is a flexible flake, the flexible flake has a side board, and the second positioning portion is located on the side board.

4. The external hard disk box as claimed in claim 1, wherein the positioning structure includes an external mask, a spring flake, and a pushing element, the external mask has a through hole that corresponds to the second positioning portion, one end of the spring flake is connected with the external mask, a second end of the spring flake is a free end and has the second positioning portion, and the pushing element is slidably located in the external mask and contacts the second end of the spring flake.

5. The external hard disk box as claimed in claim 1, wherein the positioning structure is a flexible element, one side of the flexible element bends to form a linking flake, one end of the linking flake is a free end and forms a pushing portion, and the pushing portion extends to form the second positioning portion.

6. The external hard disk box as claimed in claim 5, wherein the upper cover is slidably assembled with the lower cover, two leg columns extend from two sides of the bottom surface of the upper cover, and the leg column corresponds to the pushing portion.

7. The external hard disk box as claimed in claim 6, wherein there is a first wedged portion and a second wedged portion on the lower cover and the upper cover.

8. The external hard disk box as claimed in claim 5, wherein each of the flexible elements bends upwards to form at least one curved portion, and the curved portion pushes and contacts a bottom surface of the upper cover.
